(19) United States
(12) Patent Application Publication
(10) Pub. No.: US 2006/0034201 A1
(43) Pub. Date: Feb. 16, 2006

(54) Taxi dispatching system and dispatching method

(75) Inventors: Nobutoshi Umeda, Tokyo (JP); Kiyoshi Oyama, Yokote-shi (JP)

Correspondence Address: BRUCE L. ADAMS, ESQ., 17 BATTERY PLACE-SUITE 1231, NEW YORK, NY, 10004, US

(73) Assignee: Nobutoshi UMEDA

(21) Appl. No.: 11/185,655

(22) Filed: Jul. 20, 2005

(30) Foreign Application Priority Data
Jul. 28, 2004 (JP) 2004-219980

(51) Int. Cl. H04B 7/00

(52) U.S. Cl. 370/310

(57) ABSTRACT

A taxi customer requests a taxi dispatch using a mobile phone. A control center acquires the request and authenticates the telephone number by an incoming call log thereof, and then sends an e-mail with a URL to the e-mail address of the taxi customer. The taxi customer accesses the URL and inputs dispatch conditions, and these dispatch conditions are distributed to a plurality of taxi drivers. The control center selects the optimal taxi based on the offer or bid from the taxi drivers that satisfies the dispatch conditions. The taxi customer is notified of the selection, and the taxi driver and the taxi company are also automatically notified that a selection was made. Such an arrangement enables a taxi to be automatically dispatched without the need for a telephone conversation to the taxi customer who has specified the dispatch conditions. The taxi customer can therefore reliably take a taxi with the desired conditions.

### BACKGROUND OF THE INVENTION

1. Field of the Invention

The present invention relates to a taxi dispatching system and dispatching method, and more particularly relates to a taxi automatic dispatching system and a taxi automatic dispatching method that uses an e-mail function and a Web function to dispatch, via the Internet, a taxi in response to a request via a telephone (incoming call) from a taxi customer.

2. Description of the Prior Art

To take a taxi, one ordinarily either goes to a taxi boarding location, such as in front of a station, or hails a taxi on a main street; however, in reality, it often happens that one does not know where there is a taxi boarding location, outside of designated facilities, such as in front of a station, a hospital, or a hotel, and it is also not easy to hail a taxi on back streets, and the like. Other means include telephoning a taxi company or a dispatch service center, and requesting the wireless dispatch of a taxi; however, this is not generally available to just anyone, and the service system is inadequate because of problems such as not knowing the telephone number to contact.

Taxis, on the other hand, search for customers by cruising the streets (main streets), but it is often problematic to find passengers, such as at night; therefore, they wait for customers by parking on the streets, such as in front of stations and hotels, or in shopping districts. However, the present situation is unbalanced because, when the economy is in a recession, an excessive number of taxis sit waiting for customers.

In addition, to improve the customer service of taxi drivers, an outside order is placed with a specialized company to evaluate (undercover test) the drivers.

Conventionally, there are also services being considered that, for a customer searching for a taxi (a taxi customer), search for a taxi company suited to the dispatch conditions, and provide the taxi customer with the name and telephone number of the taxi company. However, even with such a service and even if the customer receiving the service makes a dispatch request to the taxi company, there are cases in which that taxi company does not have a free taxi, and cases in which it takes a long time until the taxi is dispatched, and the customer therefore has no alternative but to search once again for a taxi. Accordingly, the conventional service is customer unfriendly.

In addition, a taxi company requires the hand of an experienced operator to verbally provide the taxi information to the taxi driver.

It is therefore an object of the present invention to provide a taxi dispatching system and dispatching method that enables anyone to easily call a taxi using a simple method.

### SUMMARY OF THE INVENTION

According to the invention, a system for dispatching a taxi in response to a request from a taxi customer made by telephone comprises means for storing a telephone number of the taxi customer in association with an e-mail address thereof; means for acquiring the telephone number of the taxi customer who has requested a taxi and sending an e-mail including a URL to the e-mail address of the taxi customer corresponding to the acquired telephone number; means for acquiring dispatch conditions that the taxi customer has entered by accessing said URL and distributing a dispatch request to taxi drivers that comply with said dispatch conditions; means for receiving offers from taxi drivers that satisfy said dispatch conditions and selecting a taxi suited to the dispatch conditions of the taxi customer; and means for notifying the requesting taxi customer of information of the selected taxi and notifying the selected taxi driver or the taxi company thereof that the taxi has been selected.

According to the invention, a method is further provided for dispatching a taxi in response to a request from a taxi customer made by telephone. The method comprises the steps of previously storing a telephone number of the taxi customer in association with an e-mail address thereof; acquiring the telephone number of the taxi customer who has requested a taxi and sending an e-mail including a URL to the e-mail address of the taxi customer corresponding to the acquired telephone number; acquiring dispatch conditions that the taxi customer has entered by accessing said URL and distributing a dispatch request to taxi drivers that comply with said dispatch conditions; receiving offers from taxi drivers that satisfy said dispatch conditions and selecting a taxi suited to the dispatch conditions of the taxi customer; and notifying the requesting taxi customer of information of the selected taxi and notifying the selected taxi driver or the taxi company thereof that the taxi has been selected.

Such an arrangement enables a taxi customer, including the hearing impaired, elderly people, people in need of care, and the like, to reliably take a taxi under desired conditions because the taxi is dispatched in accordance with pickup conditions (dispatch conditions) specified by the taxi customer, without the need for human intervention or a telephone conversation.

In the present invention, a telephone is a mobile phone provided with an e-mail function and a Web browser function, and the dispatch conditions are input by accessing a Web server denoted in a URL. In addition, a request identification number, which differs for each taxi dispatch request, is embedded in this URL; further, when the dispatch conditions are acquired, this request identification number is also acquired and stored in association with dispatch conditions. By embedding the request identification number in the URL, the system can associate and store the dispatch conditions and the taxi information for each such request identification number at the time of the dispatch request. This makes the processing of the various data, the distribution of the dispatch request, and the management of the taxi information reliable.

In addition, if the mobile phone is provided with a function that can specify the position of the mobile phone, then positional information of the mobile phone is added to the dispatch conditions as the boarding location where the taxi customer will wait for the taxi. This enhances the positional accuracy of the boarding location.

Further features of the invention, its nature and various advantages will be more apparent from the accompanying drawings and following detailed description of the invention.

### BRIEF DESCRIPTION OF THE DRAWINGS

FIG. 1 is a block diagram that depicts the entire constitution of the taxi automatic dispatching system of the present invention.

FIG. 2 is a flow chart that depicts the flow by which the telephone number of a taxi customer is registered.

FIG. 3a through FIG. 3c are a screenshot that depicts the screen of a mobile phone when registering its telephone number.

FIG. 4a through FIG. 4d are an explanatory diagram that depicts the various databases and tables stored in the control server.

FIG. 5 is a flow chart that depicts the flow when a taxi customer requests the dispatch of a taxi.

FIG. 6a through FIG. 6c are a screenshot that depicts the screen of a mobile phone when a taxi customer requests the dispatch of a taxi.

FIG. 7a is a screenshot that displays the contents of an e-mail distributed to a taxi driver who complies with the dispatch conditions.

FIG. 7b is a screenshot that displays the contents of an e-mail distributed to the selected taxi driver.

### DESCRIPTION OF THE PREFERRED EMBODIMENTS

The present invention will be described based on preferred embodiments, referring to the attached drawings.

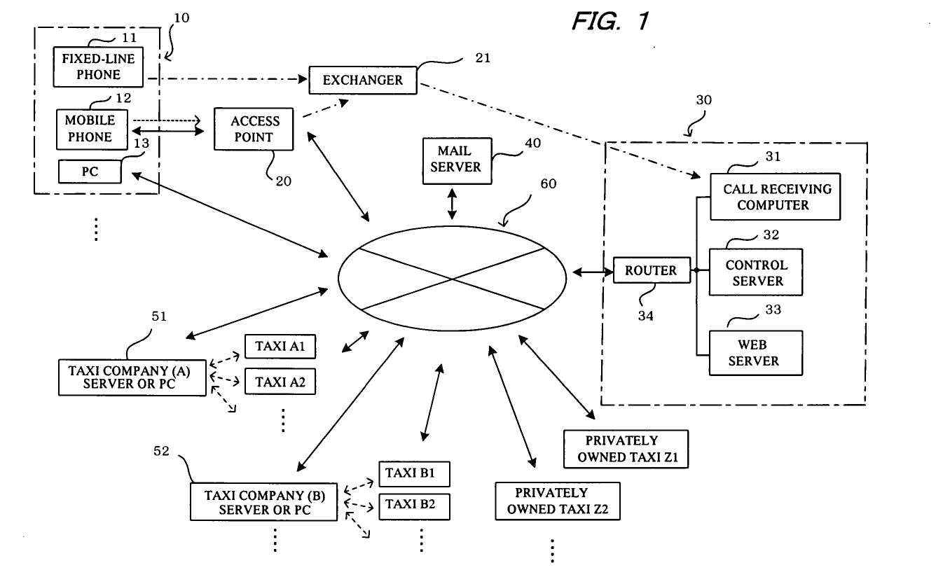

FIG. 1 depicts the entire configuration of a taxi dispatching system, which as a whole comprises: customers 10, . . . who want to take a taxi; a dispatch control center 30 that constitutes the main part of the dispatching system; taxi companies 51, 52, . . . and their subordinate taxi groups; as well as privately owned taxis, and the like.

The taxi customer 10 possesses a mobile phone 12 having an ordinary e-mail function and a browser function that accesses and browses a Web server, such as by the i-Mode service, and the taxi customer 10 inputs various information and makes requests, such as for the dispatch of a taxi, from this mobile phone 12. When making a telephone call, the customer 10 uses the mobile phone 12 to wirelessly (depicted by dotted line) access a mobile phone access point 20, and receives incoming messages via an exchanger 21.

In addition, when connecting to an Internet 60, such as to send and receive an e-mail or to browse a Web page, it is possible to use the e-mail function and the browser function of the mobile phone 12 to connect to the Internet 60 via the mobile phone access point 20. This connection is accomplished using the TCP/IP protocol by way of a contracted provider. This is indicated by the solid double arrow line. Communication by connecting to the Internet 60 by various devices, computers, and servers, is accomplished via a provider; however, the provider is omitted from the drawings in order to avoid complicating the drawing.

In addition, the taxi customer 10 can use a fixed-line phone 11 to communicate by an ordinary telephone line via the exchanger 21, and can also send and receive e-mail and access a Web server by connecting to the Internet using a PC (personal computer) 13.

The dispatch control center 30 comprises an incoming call receiving computer 31 that accommodates a plurality of telephone lines that receives incoming messages from the mobile phone 12 or the fixed-line phone 11 of the taxi customer 10; this incoming call receiving computer 31 stores a table that associates the inbound line telephone number and the server address; and can specify an address, such as that of a Web server, by a telephone number acquired from a customer telephone call.

In addition, the dispatch control center 30 comprises a control server 32 that controls overall dispatch control and charges, and that stores various data, as well as a Web server 33, and these computers and servers 31, 32, 33 are connected by a LAN, which is connectable to the Internet 60 via a router 34. The Web server 33 is a separate server, but can also be integrated with the control server 32, or can also be provided external to the dispatch control center 30. Likewise, the control server 32 can also be provided with an incoming call receiving function, and the incoming call receiving computer 31 can be omitted in such a case. In addition, the incoming call receiving computer 31 can also be provided external to the dispatch control center 30, and the control server or the Web server can also be implemented by renting a server supplied by the provider.

In addition, mobile phones owned by a plurality of taxi drivers A1, A2, B1, B2, . . . are connectable to the Internet 60. Because the taxi drivers A1, A2, . . . belong to a taxi company (A), they can use a server or a PC of the taxi company (A) 51 as a server. In addition, because the taxi drivers B1, B2, . . . belong to a taxi company (B), they can use a server or PC of a taxi company (B) 52 as a server. There are also cases in which the taxi drivers belonging to each taxi company can exchange information with the taxi company by a mobile phone and an ordinary wireless information sending and receiving system, and that exchange is depicted by a dotted double arrow line. Taxis are not just the taxis belonging to such companies, but can also include privately owned taxis Z1, Z2, . . . ; in the case of a privately owned taxi, information is exchanged by connecting to the Internet 60 by a mobile phone owned by the driver of the privately owned taxi.

In the present invention, information is sent and received basically via e-mail. Accordingly, each taxi customer, dispatch control center, taxi company, taxi driver, and the like, has a unique e-mail address, and there is a mail server that provides individual accounts therefor; however, to avoid complicating the drawings, these are depicted as a single mail server 40 in a form that integrates these mail servers.

The following explains the flow by which a taxi is dispatched in such a configuration.

A taxi customer normally requests a taxi dispatch via a mobile phone; therefore, to prevent improper requests and prank requests, the telephone number is registered, the taxi customer is authenticated by the telephone number, and service is provided only to those for which the request is from a registered telephone number.

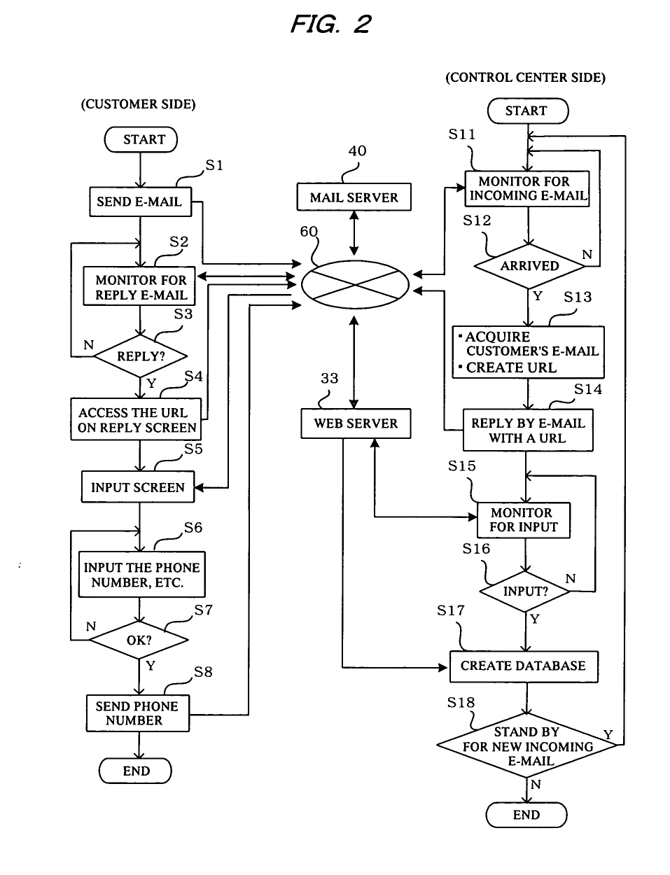

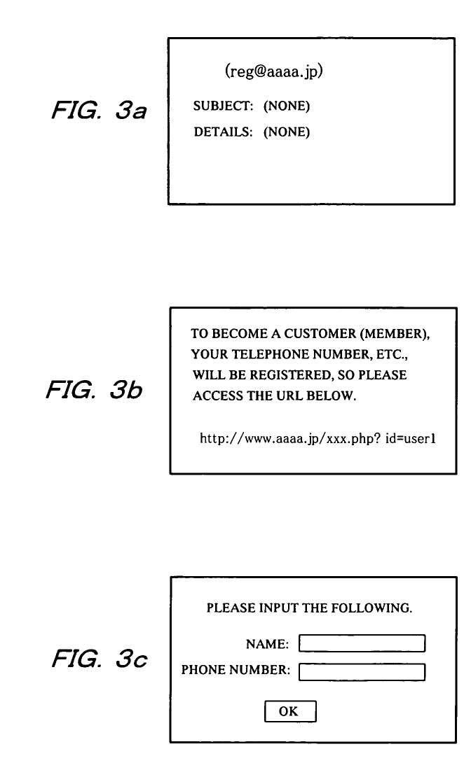

Consequently, the telephone number is registered, and this processing is depicted in the flow chart of FIG. 2. First, in step S1, the taxi customer 10 uses the mobile phone 12 or the PC 13 to transmit an e-mail, without entering a subject or message, to the e-mail address (reg@aaaa.jp) of the dispatch control center 30, as shown in the screen in FIG. 3a. At the dispatch control center 30, the control server 32 accesses the mail server 40 at a prescribed interval, and monitors for the arrival of an incoming e-mail (steps S11, S12). If an e-mail arrives for the registration of a telephone from a taxi customer, then the control server 32 acquires the telephone number and the e-mail address of the taxi customer, stores these in memory, creates a URL (Uniform Resource Locator) (step S13) and replies to the taxi customer 10 with an e-mail that includes the URL (step S14).

The taxi customer 10 accesses the mail server 40 and monitors for a reply from the dispatch control center 30 (step S2); if there is a reply (step S3), then a screen prompting the input of the included URL appears on the screen of the mobile phone 12 or the PC 13 of the taxi customer, as shown in FIG. 3b, and the taxi customer then accesses the displayed URL (step S4).

Because the URL denotes the address “www.aaaajp” of the Web server 33 of the dispatch control center 30, the taxi customer can access the Web server 33 of the dispatch control center 30, execute the xxx.php program recorded at that URL, and display as an input screen the screen as shown in FIG. 3c on the screen of the mobile phone 12 or the PC 13 (step S5). Then, the taxi customer 10 inputs their own name and telephone number (normally, the telephone number of their own mobile phone) (step S6), presses an “OK” button after confirmation (step S7), and sends the inputted data to the Web server (step S8).

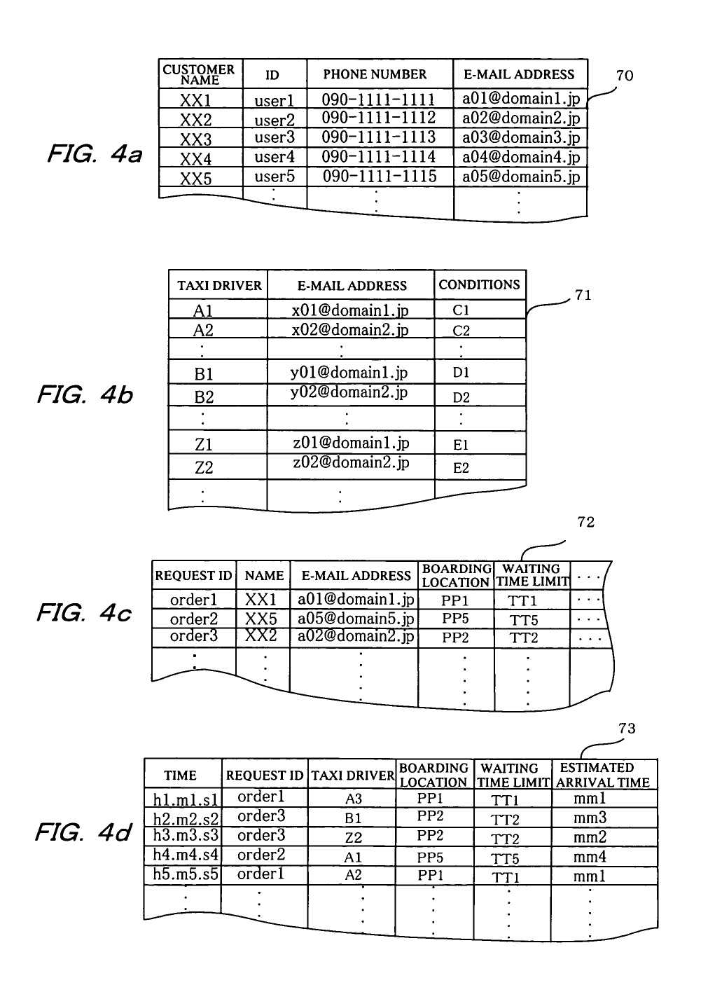

The control server 32 monitors the Web server 33 (step S15); if an input from the taxi customer is confirmed (step S16), then the control server 32 creates a database 70, comprising the customer's name, identification ID, telephone number, e-mail address, and the like, using the telephone number as the index key, as shown in FIG. 4a, and stores such in the storing means in the control server (step S17). Here, the customer's name and telephone number are those inputted by the customer in step S6; as the identification ID a variable (id=user1) (FIG. 3b) is used that is embedded in the URL in Step S13 for each taxi customer that has made an application; and the e-mail address is the one acquired in step S13. Since these are uniquely associated, they can be stored as one record in the database.

If it is decided to monitor for a new incoming e-mail in step S18, then the method returns to step S11, and repeats the abovementioned processing. Thus, the data of the taxi customers are successively registered, and the database 70 as shown in FIG. 4a is created. Furthermore, the data input by the customer and stored in the database was minimally the name and telephone number; however, as needed, it is possible to have the customer input their address, gender, age, and the like, and to store such in the database.

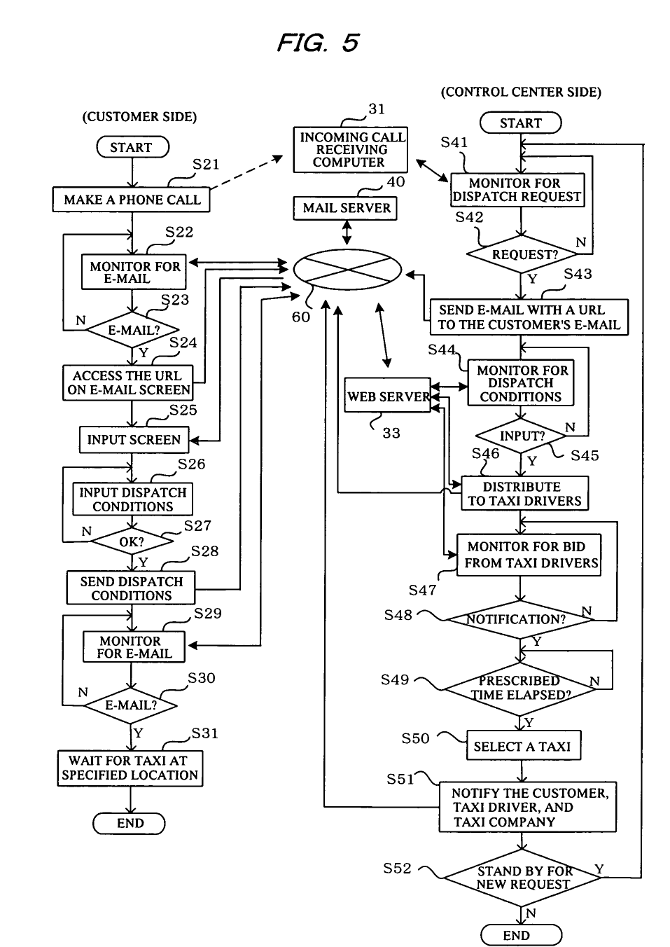

The following explains the flow when a taxi customer requests a taxi using the taxi dispatching system, referencing FIG. 5.

First, the taxi customer 10 uses the mobile phone 12 to make a telephone call to the designated telephone number of the control center 30 (step S21). At this time, to economize on calling charges, the telephone call is terminated upon arrival. At the control center, the incoming call receiving computer 31 monitors for a dispatch request by this incoming call (step S41); if there is an incoming call for a dispatch request (step S42), then the incoming call receiving computer 31 can acquire the telephone number of the taxi customer, and therefore accesses the database 70 (FIG. 4a) stored in the storing means of the control server 32, acquires the e-mail address corresponding to the telephone number of the taxi customer, and sends to that e-mail address an e-mail including a URL (step S43; sending means).

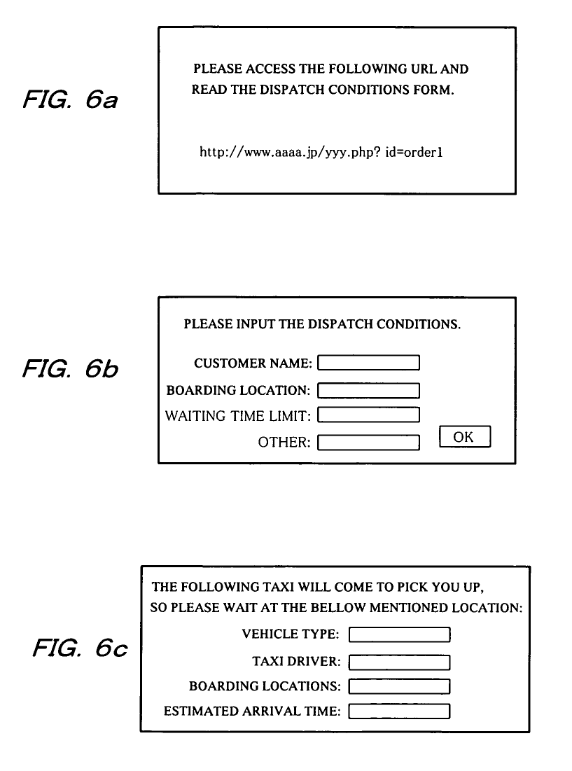

The taxi customer monitors for the arrival of this e-mail (step S22); if there is an e-mail (step S23), then that e-mail screen forms a screen as shown in FIG. 6a, and the taxi customer accesses the Web server 33 by selecting the URL (step S24). At this time, the input screen as shown in FIG. 6b appears on the screen of the mobile phone (step S25). Furthermore, the (id=order1) embedded in this URL is appended for each application, and is therefore used as the request identification number.

The taxi customer views this input screen, and inputs the dispatch conditions (step S26). The boarding location, the waiting time limit, and the like, are input as the dispatch conditions. The name, and the like, from the database 70 can be pre-inputted as a default for the customer name, thereby reducing the number of items input by the customer. In addition, a marker, such as a facility, restaurant, or convenience store that the taxi can easily identify is appended, without manual input, as the boarding location. Consequently, it is also conceivable to pre-display the facility name, the location, and the like, from the database, and to select such by checking one. In addition, there are also mobile phones that are provided with a GPS function (global positioning system), and it is therefore also possible to append the positional information of the mobile phone obtained by this function.

Furthermore, if the taxi boarding location (the waiting spot) is made a convenience store, a family restaurant, or the like, then the taxi customer can ensure their safety (security) late at night, and the like, by spending their boarding waiting time inside a store; further, because an advertisement related to each of the waiting spots can be distributed to the taxi customer, it can also contribute to the sales volume of convenience stores, family restaurants, and the like.

In addition, by providing a waiting time limit as a dispatch condition, it is possible to inquire how long the taxi customer can wait until the boarding time; further, if other conditions, such as the required number of vehicles, the vehicle type (midsize, compact, etc.), and the like, are required, then a menu is displayed as a separate screen, and the conditions are made selectable. In this case, there is no need for a telephone conversation (verbally).

If such dispatch conditions are input, and the OK button is operated (step S27), then the dispatch conditions are transmitted to the Web server 33 via the Internet 60 (step S28).

On the other hand, the control center monitors for the transmission of the dispatch conditions of a taxi customer (step S44). If the input of dispatch conditions is detected at the Web server (step S45), then the dispatch conditions are converted to a table 72, as shown in FIG. 4(C), and stored. In this table 72, the request identification number is the number (id=order(n)) embedded in the URL created in step S43 and appended to each dispatch request; the name, boarding location, and waiting time limit are the dispatch conditions input in step S26; and the e-mail address is the one corresponding to the customer name stored in the database 70. If other dispatch conditions are further input in step S26, then these dispatch conditions are stored in the table 72 associated therewith.

Continuing, these dispatch conditions and the request identification number of the dispatch are distributed via the Internet to participating taxi drivers (step S46; distributing means). Because a database 71, wherein the e-mail addresses of the participating taxi drivers are registered, is stored in the control server 32, as shown in FIG. 4b, all dispatch conditions are simultaneously distributed from the control server to the participating taxi drivers that comply with the conditions.

Furthermore, dispatch conditions compliance can be determined by comparing pre-recorded data C1, C2, D1, D2, E1, E2, which constitute the dispatch conditions associated with each driver, as shown in FIG. 4b, comprising the taxi vehicle type, wheel chair accessible vehicle, non-smoking car, driver gender, whether they have long-term care insurance, and the like, with the data recorded as the dispatch conditions requested by the taxi customer. Thus, a suitable taxi can be preselected by distributing pickup requests only to taxi drivers that comply with the dispatch conditions or are suited to the dispatch conditions. For example, if a female driver has been made one of the conditions, then a request is distributed only to female drivers, etc.

The dispatch requests are successively distributed, via the Internet to the taxi drivers A1, A2, B1, B2, Z1, Z2, . . . that comply with the conditions, as e-mails, which include a URL, to the e-mail address of the mobile phone of each taxi driver.

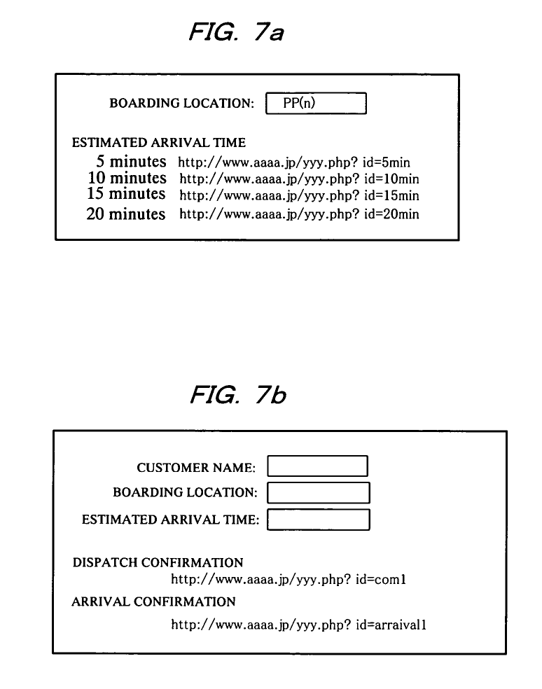

FIG. 7a depicts the contents of an e-mail with this URL, and a plurality of URLs is created in accordance with the waiting time limits “TT(n)” specified by the taxi customer. For example, if the waiting time limit were 20 minutes and URLs were created in 5-minute steps, then four URLs would be displayed; 5-minute, 10-minute, 15-minute, and 20-minute. In addition, because the boarding location “PP(n)” specified by the taxi customer is displayed, a taxi driver can judge whether they can bid by browsing this distributed e-mail. For example, if they can arrive at “PP(n)” in 10 minutes, then the taxi driver selects the 10-minute URL. Thus, the taxi driver can notify (bid), on one's own, the Web server 33 of the taxi offer information (bid) via the Internet, employing few operations (one-click operation).

The control center detects the notification from the taxi driver (steps S47, S48), and creates a table 73, as shown in FIG. 4d, with each receipt of a notification. In this table 73, the time is when the request identification number and the offer information associated therewith were notified (bid). The table 73 is updated upon each notification. The request identification number ID and the boarding location in the table 73 can be learned by the reply (bid) to the e-mail that was distributed to the taxi driver, and the taxi driver, the vehicle type, and the like, can be learned from the registered information (FIG. 4b) associated with the e-mail address of the taxi driver to whom information was distributed; furthermore, the estimated time of arrival can be learned from the URL selected by the driver. If, for example, the taxi driver has selected the 10-minute URL, then 10 minutes is recorded.

If the control center receives a dispatch request and the prescribed time (e.g., 3 minutes has elapsed (step S49), then a taxi suited to the dispatch conditions of the taxi customer is selected (step S50; selecting means). Various selection algorithms are conceivable, but the simplest one is to give priority to the taxis whose estimated time of arrival to the boarding location is earliest, and to select the taxi related to the offer information (bid) that was first notified. For example, in the example shown in FIG. 4d, there are two candidates for the “order1” request; however, because both of them have the same estimated time of arrival, the one with the earliest notification time is selected. Namely, the driver A3 whose time is “h1.m1.s1” is selected. Alternatively, it is possible to provide a performance evaluation coefficient for each taxi driver, and to take this into account when making the selection.

If a taxi is selected in this manner, then the taxi customer who made the dispatch request is notified via e-mail of information that enables them to identify the selected taxi, such as the name of the taxi driver, the boarding location, and the estimated time of arrival. Notification, including the request identification number, to the effect that the taxi has been selected is also given via the Internet to the taxi company to which the taxi belongs and/or the taxi driver, or to the private taxi driver (step S51; notifying means). In addition, the charge to the taxi company or to the private taxi driver is set at this stage of the notification. The system stands by for a new request (step S52), and returns to step S41 and monitors for the arrival of a dispatch request.

During this time, the taxi customer monitors for the receipt of an e-mail (step S29). If there is an e-mail (step S30), then the taxi customer browses it. Because a screen as shown in FIG. 6c appears on the screen of the mobile phone, the taxi customer waits for the taxi at the specified boarding location (step S31). Furthermore, on the screen in FIG. 6c, the taxi vehicle type is information that makes it easy for the customer to identify the taxi, such as the vehicle license plate number or maker; in addition, the boarding location, the estimated time of arrival, and the like, are displayed that were specified as the dispatch conditions by the taxi customer.

The taxi that was suited to that dispatch request, i.e., the selected taxi driver, is automatically notified to that effect by an e-mail, as shown in FIG. 7b (step S51), and that taxi can therefore go to the specified boarding location at the specified estimated time of arrival to pick up the taxi customer. The taxi driver reports in advance of the fact of the dispatch to the control center and the taxi company via the Internet. This is reported by clicking the dispatch verification URL in FIG. 7b.

If the taxi company has not received a notification from the taxi driver that he or she has been dispatched (that he or she has departed for the boarding location) even though 90 seconds (time can be arbitrarily set) has elapsed since notification was received from the control center, then the taxi company's computer sounds a warning.

In addition, the taxi driver notifies the control center and the taxi company via the Internet of the information that the taxi has arrived at the specified boarding location. This is reported by selecting the arrival confirmation URL in FIG. 7b. When this notification is issued, an e-mail is transmitted to the taxi customer informing them of the arrival, and this e-mail includes a URL that allows for the evaluation of the taxi driver.

In addition, if there has been no notification of an e-mail from the taxi driver informing of their arrival even though 120 seconds (time is arbitrarily settable) has elapsed since the estimated arrival time, then the taxi company computer issues a warning sound.

Once the taxi customer selects a taxi, or if they do not actually board the taxi because they are absent from the boarding location due to leaving the boarding location without notice, and the like, then a cancellation fee is charged to the taxi customer. The details and method of collection of the charge varies by taxi company, and the taxi company bears the obligation for that collection. If the same taxi company is selected the next time by a dispatch request made by the same taxi customer and the taxi customer boards a taxi of that taxi company, then the previous cancellation information is sent by e-mail to the mobile phone of the current taxi driver, and the previous cancellation fee can be collected by surcharging the present fare.

Although program steps on the control center side shown in FIG. 5 are executed in the control server 32, that execution may be distributed and partially executed in the Web server 33. In addition, if constituted so that the function of the Web server 33 is executed in the control server 32, then the Web server may be omitted; however, because a Web server is in principle externally exposed, it is preferable to make it a separate server from a security standpoint. In addition, the computer 31 that receives incoming phone calls from customers may be substituted by the Web server 33.

Although the abovementioned dispatch control center 30 is disposed at a location separate from the taxi company, it can also be provided within a prescribed taxi company, or a prescribed taxi center. In such a case (closed operations), dispatch conditions are distributed only to that taxi company or to the taxis belonging to the center, and the choices available to the taxi customers would therefore be limited; however, the equivalent effects are obtained if that company is operating numerous taxis in the region, and if there are numerous customers in that region.

As explained above, in the present invention, the dispatch request of a taxi customer is distributed to numerous taxi drivers by a simple method, and a taxi suited to the dispatch conditions of the customer is selected from among taxi drivers who have responded (open operations). Therefore, the taxi customer can reliably board a taxi with the desired conditions.

In addition, in the present invention, the tool by which a dispatch request is made by a taxi customer (including the hearing impaired, elderly people, and persons in need of care), a taxi company, and a taxi driver, is not a telephone conversation, but rather an e-mail (communication); consequently, the taxi customer does not need to memorize the telephone number of the taxi company. In addition, other effects obtained include: communications costs can be substantially reduced; e-mails can be saved in the mobile phone, and the like, and there is consequently no need to write down the dispatch conditions; and the dispatch request history can also be saved.

In addition, in the present invention, taxis are dispatched in an unattended mode. Unattended herein means that the dispatch is completed, without human intervention, from the dispatch request to the dispatch completion by the mobile phone of the taxi customer, the servers, and the mobile phone of the taxi driver; the PC at the taxi company is used for monitoring for dispatch requests.

In addition, in the present invention, if the taxi customer specifies the boarding location to be a convenience store, a family restaurant, and the like, then the taxi customer uses data like the location of the boarding location, making it unnecessary for the taxi customer to know the precise location of a boarding location, and saving on the amount of inputting.

In addition, if the taxi customer specifies a convenience store, a family restaurant, and the like, when specifying the boarding location at which they will wait for a taxi in the dispatch conditions input by accessing a URL, then it is possible to provide a service of transmitting an advertisement suited to the boarding location during the taxi customer's waiting time. In that case, numerous opportunities arise because the transmission of the advertisement can be timed to the free time while the taxi customer is waiting for the taxi, and since the boarding location and the purchasing location are the same place, it is directly linked to purchasing (sales), and therefore becomes an extremely effective promotional tool.

In addition, when the taxi driver has arrived at the boarding location, the taxi customer is notified of that arrival by e-mail. A URL for evaluating the taxi driver is appended to that notification, and the taxi customer can thereby provide an evaluation of the customer service (did the taxi arrive at the estimated time, was the driver courteous, and the like) while riding or after getting out of the taxi, and can directly report that evaluation to the taxi company.

Thus, it is a significant point that the automation of the dispatching system eliminates the need for an experienced operator; in addition, because the dispatching system selects from among the taxis that satisfy the taxi customer's own dispatch conditions the taxi that will come soonest to the boarding location, there is no need for the taxi customer to memorize the telephone number of the taxi company, and the like.

In addition, because the personal information of the taxi driver is registered in advance, a dispatch request is sent by e-mail to the mobile phone only of taxi drivers that comply with the dispatch conditions, thereby preventing the reception of numerous useless e-mails (dispatch requests) by taxi drivers.

In addition, the method by which taxi drivers have been evaluated until now has been for an undercover researcher (requested of another company) to ride the taxi; however, it is possible to perform the evaluation by the actual taxi customer merely by having the taxi customer click on a URL appended to the arriving e-mail.

In addition, the e-mail advertisement provided during the waiting time may also be selected and distributed in accordance with the current state of the customer. For example, to a taxi customer who has made a convenience store their boarding location, an advertisement for a product displayed at the convenience store can be distributed; in addition, to a taxi customer who has made their boarding location the Japan Rail XX Station, an advertisement pertinent to the vicinity of the train station of the JR YY line (advertisements for restaurants and bars, and the like) can be distributed.

What is claimed is:

1. A system for dispatching a taxi in response to a request from a taxi customer made by telephone, comprising:
means for storing a telephone number of the taxi customer in association with an e-mail address thereof;
means for acquiring the telephone number of the taxi customer who has requested a taxi and sending an e-mail including a URL to the e-mail address of the taxi customer corresponding to the acquired telephone number;
means for acquiring dispatch conditions that the taxi customer has entered by accessing said URL and distributing a dispatch request to taxi drivers that comply with said dispatch conditions;
means for receiving offers from taxi drivers that satisfy said dispatch conditions and selecting a taxi suited to the dispatch conditions of the taxi customer; and
means for notifying the requesting taxi customer of information of the selected taxi and notifying the selected taxi driver or the taxi company thereof that the taxi has been selected.

2. A system as recited in claim 1, wherein said telephone is a mobile phone comprising an e-mail function and a Web browser function, and the dispatch conditions are input by accessing a Web server denoted in said URL.

3. A system as recited in claim 1, wherein a request identification number that differs for each request is embedded in said URL, and, when acquiring said dispatch conditions, the request identification number is also acquired and stored in association with the dispatch conditions.

4. A system as recited in claim 2, wherein said mobile phone comprises a function that can specify the position of the mobile phone, and the positional information of the mobile phone is appended among the dispatch conditions as a boarding location where the taxi customer will wait for a taxi.

5. A method for dispatching a taxi in response to a request from a taxi customer made by telephone, comprising the steps of:
previously storing a telephone number of the taxi customer in association with an e-mail address thereof;
acquiring the telephone number of the taxi customer who has requested a taxi and sending an e-mail including a URL to the e-mail address of the taxi customer corresponding to the acquired telephone number;
acquiring dispatch conditions that the taxi customer has entered by accessing said URL and distributing a dispatch request to taxi drivers that comply with said dispatch conditions;
receiving offers from taxi drivers that satisfy said dispatch conditions and selecting a taxi suited to the dispatch conditions of the taxi customer; and
notifying the requesting taxi customer of information of the selected taxi and notifying the selected taxi driver or the taxi company thereof that the taxi has been selected.

6. A method recited in claim 5, wherein said telephone is a mobile phone comprising an e-mail function and a Web browser function, and the dispatch conditions are input by accessing a Web server denoted in said URL.

7. A method as recited in claim 5, wherein a request identification number that differs for each request is embedded in said URL, and, when acquiring said dispatch conditions, the request identification number is also acquired and stored in association with the dispatch conditions.

8. A method as recited in claim 6, wherein said mobile phone comprises a function that can specify the position of the mobile phone, and the positional information of the mobile phone is appended among the dispatch conditions as a boarding location where the taxi customer will wait for a taxi.
